(19) United States
(12) Patent Application Publication
(10) Pub. No.: US 2022/0001683 A1
(43) Pub. Date: Jan. 6, 2022

(54) Automatic Document Feeder With One Belt And One Tensioner For All Drive Rollers To Keep Them Synchronized And Reduced Scan Image Errors

(71) Applicant: Hewlett-Packard Development Company, L.P., Spring, TX (US)

(72) Inventors: Rene O. Valenzuela-Rivas, San Diego, CA (US); Ryan M. Smith, San Diego, CA (US)

(73) Assignee: Hewlett-Packard Development Company, L.P., Spring, TX (US)

(21) Appl. No.: 17/298,617

(22) PCT Filed: Jul. 31, 2019
(86) PCT No.: PCT/US2019/044457

§ 371 Date: May 31, 2021

(51) Int. Cl. B41L 21/02; B65H 29/12; B65H 3/06

(52) U.S. Cl. CPC B41L 21/02; B65H 29/125; B65H 2801/06; B65H 2403/25; B65H 2801/39; B65H 3/0669

(57) ABSTRACT

An automatic document feeder includes a media path to route media through the automatic document feeder, a plurality of opposing roller pairs to route media along the media path, and a serpentine belt drive system to drive a roller of each of the opposing roller pairs.

### BACKGROUND

An automatic document feeder may be used for automatically transporting a sheet of media to an imaging or scanning position for copying, scanning, faxing, displaying on a monitor, or other processing. Thereafter, the automatic document feeder may eject the media and process a next sheet of media.

### BRIEF DESCRIPTION OF THE DRAWINGS

FIG. 1 is a schematic diagram illustrating an example of an automatic document feeder including an example of a serpentine belt drive system.

FIG. 2 is a block diagram illustrating an example of an inkjet printing system including an example of an automatic document feeder.

FIG. 3 is a side view illustrating an example of a portion of an automatic document feeder including an example of a serpentine belt drive system.

FIG. 4 is a perspective view illustrating an example of a portion of an automatic document feeder including an example of a serpentine belt drive system.

FIG. 5 is a flow diagram illustrating an example of a method of driving rollers of an automatic document feeder.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure.

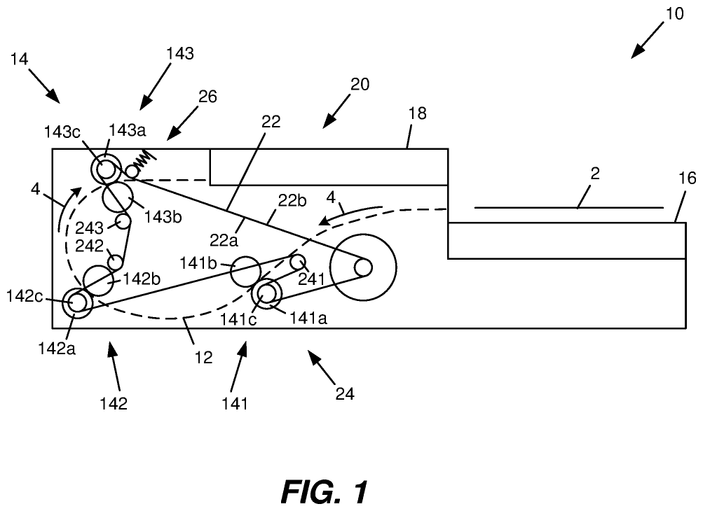

As illustrated in the example of FIGS. 1A and 1B, the present disclosure provides an automatic document feeder (ADF) 10. In one implementation, ADF 10 includes a media path 12 to route media 2 through ADF 10, as represented by arrows 4, a plurality of opposing roller pairs 14 to route media along media path 12, and a serpentine belt drive system 20 to drive a roller of each of the opposing roller pairs 14.

In examples, the opposing roller pairs 14 include a pre-scan roller pair 141, including rollers 141a, 141b, a post-scan roller pair 142, including rollers 142a, 142b, and an exit roller pair 143, including rollers 143a, 143b. In implementations, serpentine belt drive system 20 includes a single, continuous belt 22 to drive a roller of each of the opposing roller pairs 14. For example, in implementations, belt 22 drives roller 141a of pre-scan roller pair 141, drives roller 142a of post-scan roller pair 142, and drives roller 143a of exit roller pair 143.

In implementations, belt 22 has a first side 22a and a second side 22b opposite first side 22a, such that first side 22a of belt 22 contacts a drive element of each of the opposing roller pairs 14. For example, in implementations, first side 22a of belt 22 contacts a drive element 141c of pre-scan roller pair 141, contacts a drive element 142c of post-scan roller pair 142, and contacts a drive element 143c of exit roller pair 143.

In implementations, serpentine belt drive system 20 includes a plurality of idler pulleys 24 to guide belt 22 around the drive element of a respective one of the opposing roller pairs 14, such that second side 22b of belt 22 contacts idler pulleys 24. For example, in implementations, serpentine belt drive system 20 includes an idler pulley 241 to guide belt 22 around drive element 141c of pre-scan roller pair 141, an idler pulley 242 to guide belt 22 around drive element 142c of post-scan roller pair 142, and an idler pulley 243 to guide belt 22 around drive element 143c of exit roller pair 143, such that second side 22b of belt 22 contacts idler pulley 241, contacts idler pulley 242, and contacts idler pulley 243.

In implementations, serpentine belt drive system 20 includes a belt tensioner 26 to maintain tension on belt 22, such that belt tensioner 26 contacts second side 22b of belt 22.

As disclosed herein, an automatic document feeder, such as ADF 10, may be used to automatically transport media (one sheet or multiple sheets sequentially) along a media path, such as media path 12, from an input tray, such as input tray 16, to a scanning or imaging position, and then to an output tray, such as output tray 18. At the scanning or imaging position, the media may be scanned or imaged for copying, scanning, faxing, displaying on a monitor, or other processing. In examples, ADF 10 may be part of a printer, a scanner, a photocopier, a fax machine, or a multi-function or all-in-one device providing printing, scanning, copying, and/or faxing capabilities.

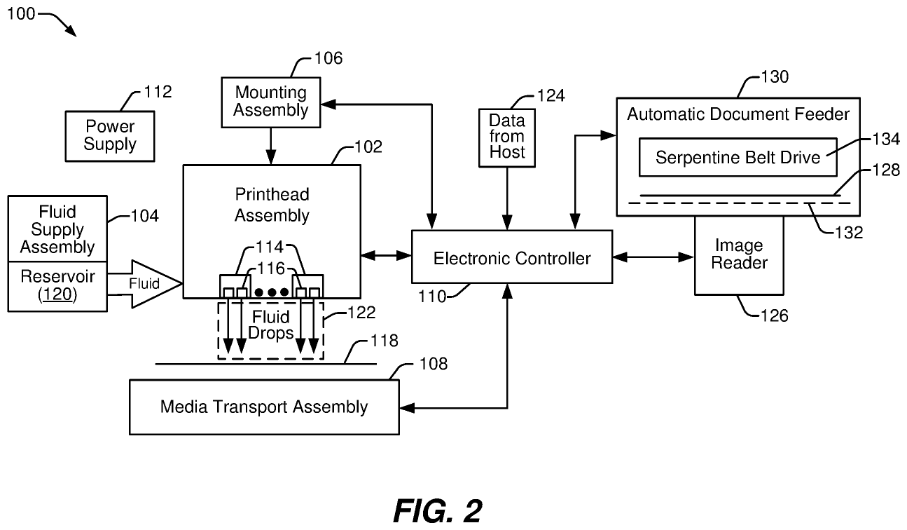

FIG. 2 illustrates an example of an inkjet printing system. Inkjet printing system 100 includes a printhead assembly 102, as an example of a fluid ejection assembly, a fluid (e.g., ink) supply assembly 104, a mounting assembly 106, a media transport assembly 108, an electronic controller 110, and a power supply 112 that provides power to electrical components of inkjet printing system 100. Printhead assembly 102 includes a printhead die 114, as an example of a fluid ejection die or fluid ejection device, that ejects drops of fluid through a plurality of orifices or nozzles 116 toward a print media 118 so as to print on print media 118.

Print media 118 can be any type of suitable sheet or roll material, such as paper, card stock, transparencies, Mylar, and the like, and may include rigid or semi-rigid material, such as cardboard or other panels. Nozzles 116 are arranged in columns or arrays such that properly sequenced ejection of fluid from nozzles 116 causes characters, symbols, and/or other graphics or images to be printed on print media 118 as printhead assembly 102 and print media 118 are moved relative to each other.

Fluid supply assembly 104 supplies fluid to printhead assembly 102 and, in one example, includes a reservoir 120 for storing fluid such that fluid flows from reservoir 120 to printhead assembly 102. In one example, printhead assembly 102 and fluid supply assembly 104 are housed together in an inkjet cartridge or pen. In another example, fluid supply assembly 104 is separate from printhead assembly 102 and supplies fluid to printhead assembly 102 through an interface connection, such as a supply tube.

Mounting assembly 106 positions printhead assembly 102 relative to media transport assembly 108, and media transport assembly 108 positions print media 118 relative to printhead assembly 102. Thus, a print zone 122 is defined adjacent to nozzles 116 in an area between printhead assembly 102 and print media 118. In one example, printhead assembly 102 is a scanning type printhead assembly. As such, mounting assembly 106 includes a carriage for moving printhead assembly 102 relative to media transport assembly 108 to scan print media 118. In another example, printhead assembly 102 is a non-scanning type printhead assembly. As such, mounting assembly 106 fixes printhead assembly 102 at a prescribed position relative to media transport assembly 108. Thus, media transport assembly 108 positions print media 118 relative to printhead assembly 102.

Electronic controller 110 includes a processor, firmware, software, memory components including volatile and non-volatile memory components, and other printer electronics for communicating with and controlling printhead assembly 102, mounting assembly 106, and media transport assembly 108.

Electronic controller 110 receives data 124 from a host system, such as a computer, and temporarily stores data 124 in a memory. Data 124 is sent to inkjet printing system 100 along an electronic, infrared, optical, or other information transfer path. Data 124 represents, for example, a document and/or file to be printed. As such, data 124 forms a print job for inkjet printing system 100 and includes print job commands and/or command parameters.

In one example, electronic controller 110 controls printhead assembly 102 for ejection of fluid drops from nozzles 116. Thus, electronic controller 110 defines a pattern of ejected fluid drops which form characters, symbols, and/or other graphics or images on print media 118. The pattern of ejected fluid drops is determined by the print job commands and/or command parameters.

Printhead assembly 102 includes one (i.e., a single) printhead die 114 or more than one (i.e., multiple) printhead die 114. In one example, printhead assembly 102 is a wide-array or multi-head printhead assembly. In one implementation of a wide-array assembly, printhead assembly 102 includes a carrier that carries a plurality of printhead dies 114, provides electrical communication between printhead dies 114 and electronic controller 110, and provides fluidic communication between printhead dies 114 and fluid supply assembly 104.

In one example, inkjet printing system 100 is a drop-on-demand thermal inkjet printing system wherein printhead assembly 102 includes a thermal inkjet (TIJ) printhead that implements a thermal resistor as a drop ejecting element to vaporize fluid in a fluid chamber and create bubbles that force fluid drops out of nozzles 116. In another example, inkjet printing system 100 is a drop-on-demand piezoelectric inkjet printing system wherein printhead assembly 102 includes a piezoelectric inkjet (PIJ) printhead that implements a piezoelectric actuator as a drop ejecting element to generate pressure pulses that force fluid drops out of nozzles 116.

In examples, inkjet printing system 100 includes an automatic document feeder (ADF) 130, as an example of ADF 10, and an image reader 126, such that ADF 130 automatically transports media 128, as an example of media 2, along a media path 132, as an example of media path 12, to and/or past image reader 126. As such, image reader 126 may acquire and/or generate an image of a side or surface of media 128.

In one implementation, ADF 130 includes a serpentine belt drive 134, as an example of serpentine belt drive system 20, to drive a plurality of roller pairs, such as opposing roller pairs 14. In examples, as disclosed herein, serpentine belt drive 134 includes a single, continuous belt to drive the plurality of roller pairs.

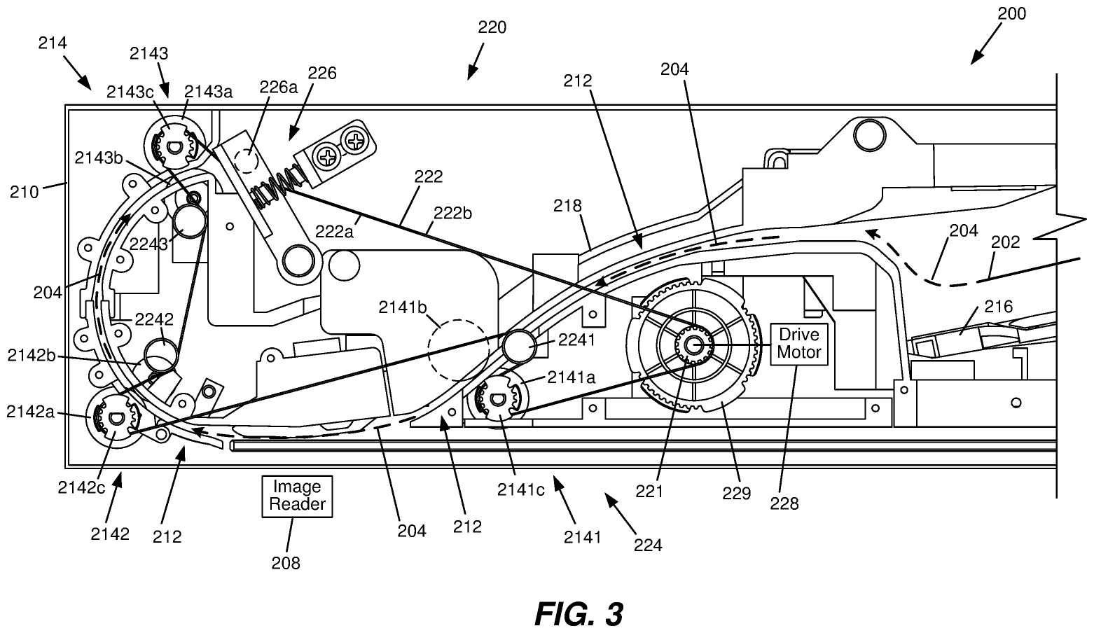

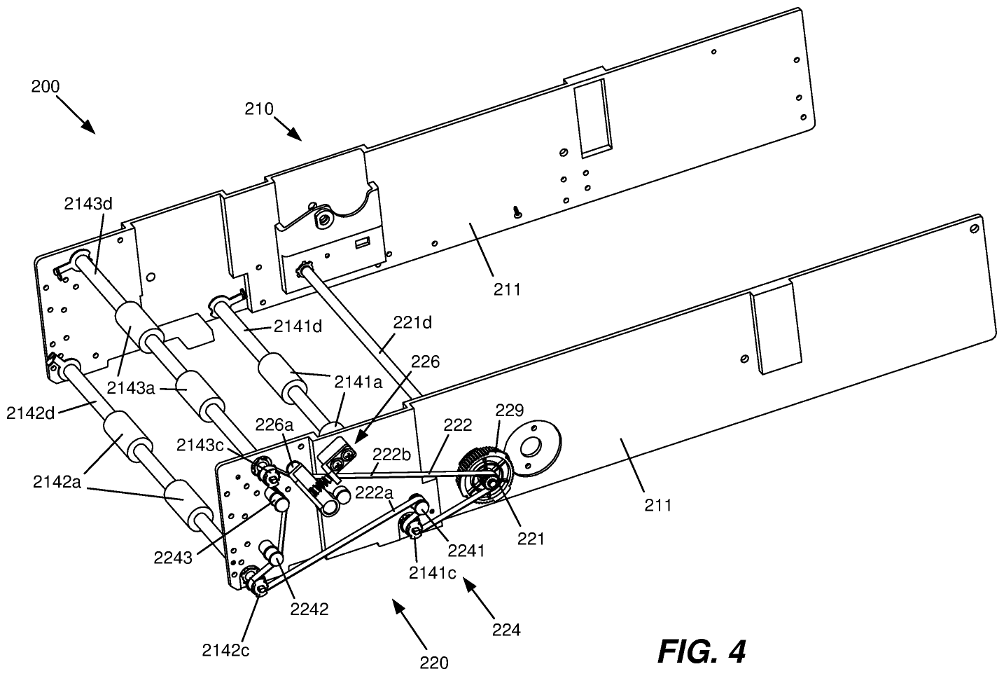

FIG. 3 is a side view illustrating an example of a portion of an automatic document feeder (ADF) 200, as an example of ADF 10, 130, including an example of a serpentine belt drive system 220, as an example of serpentine belt drive system 20 and serpentine belt drive 134, and FIG. 4 is a perspective view illustrating an example of a portion of ADF 200 including an example of serpentine belt drive system 220, as an example of serpentine belt drive system 20 and serpentine belt drive 134. In implementations, as disclosed herein, serpentine belt drive system 220 drives a plurality of opposing roller pairs 214 of ADF 200, as an example of opposing roller pairs 14.

As illustrated in the example of FIG. 3, ADF 200 includes a housing 210, and a media path 212, as an example of media path 12, 132, within housing 210 to route media through ADF 200, such as media 202, as an example of media 2, 128. In addition, ADF 200 includes an input tray 216, as an example of input tray 16, that supports and supplies media, such as media 202, for input to ADF 200, and an output tray 218, as an example of output tray 18, that receives and supports media as output from ADF 200. Accordingly, as illustrated in the example of FIG. 3, input tray 216 communicates with one end of media path 212 (i.e., an input end), and output tray 218 communicates with an opposite end of media path 212 (i.e., an output end). As such, media, such as media 202, may be routed from input tray 216 to output tray 218 along media path 212, as represented by broken line arrows 204.

In examples, media path 212 includes a variety of guides, rollers, wheels, etc. to achieve handling and routing of media, such as media 202, within and/or through ADF 200, as disclosed herein. In examples, media path 212 routes media, such as media 202, to and/or past an image reader 208, as an example of image reader 126, such that image reader 208 may acquire and/or generate an image of a side or surface of the media.

In one example, media path 212 includes a series of opposing rollers or opposing roller pairs 214 to contact and guide and/or route media, such as media 202, along and/or through media path 212. In one implementation, opposing roller pairs 214 include a pre-scan roller pair 2141, a post-scan roller pair 2142, and an exit roller pair 2143. As such, in one example, pre-scan roller pair 2141 includes rollers 2141a, 2141b, post-scan roller pair 2142 includes rollers 2142a, 2142b, and exit roller pair 2143 includes rollers 2143a, 2143b. Accordingly, rollers 2141a, 2142a, and 2143a contact one side of media in media path 212, and rollers 2141b, 2142b, and 2143b contact an opposite side of media in media path 212. In other implementations, media path 212 may include fewer or more opposing roller pairs 214.

In examples, pre-scan roller pair 2141 is positioned upstream or prior to a read or scan area of image reader 208 to guide media to and/or through the read or scan area of image reader 208, and post-scan roller pair 2142 is positioned downstream or after the read or scan area of image reader 208 to guide media through and/or from the read or scan area of image reader 208. Furthermore, exit roller pair 2143 is positioned toward, near, or at an end of media path 212 to guide media to output tray 218.

Although described as rollers, rollers of opposing roller pairs 214 may include wheels, including star wheels. Although one pre-scan roller pair 2141, one post-scan roller pair 2142, and one exit roller pair 2143 is illustrated and described, multiple pre-scan roller pairs 2141, multiple post-scan roller pairs 2142, and/or multiple exit roller pairs 2143 may be provided for media path 212.

In one implementation, at least one roller of each opposing roller pair 214 is a driven roller. For example, in one implementation, roller 2141a of pre-scan roller pair 2141 is a driven roller, roller 2142a of post-scan roller pair 2142 is a driven roller, and roller 2143a of exit roller pair 2143 is a driven roller. As such, in implementations, rollers 2141a, 2142a, and 2143a are driven, as described and illustrated herein.

In one example, each of the opposing roller pairs 214 include a drive element to drive the respective driven rollers. For example, in implementations, pre-scan roller pair 2141 includes a drive element 2141c rotatably coupled with roller 2141a, post-scan roller pair 2142 includes a drive element 2142c rotatably coupled with roller 2142a, and exit roller pair 2143 includes a drive element 2143c rotatably coupled with roller 2143a. In examples, drive elements 2141c, 2142c, and 2143c include gears or pulleys.

In one example, as illustrated in FIGS. 3 and 4, serpentine belt drive system 220 includes a drive gear or drive pulley 221, and a belt 222 driven by drive pulley 221. In implementations, drive pulley 221 is mounted on or supported by a shaft 221d (FIG. 4), and is driven by a drive motor 228 (via, in one example, a speed reduction gear or pulley 229). In implementations, belt 222 is a single, continuous belt to drive a roller of each of the opposing roller pairs 214. For example, in implementations, belt 222 drives roller 2141a of pre-scan roller pair 2141, drives roller 2142a of post-scan roller pair 2142, and drives roller 2143a of exit roller pair 2143.

In examples, rollers of opposing roller pairs 214 are mounted on or supported by a respective shaft. For example, in implementations, as illustrated in the example of FIG. 4, rollers 2141a of pre-scan roller pair 2141 are mounted on or supported by a shaft 2141d, rollers 2142a of post-scan roller pair 2142 are mounted on or supported by a shaft 2142d, and rollers 2143a of exit roller pair 2143 are mounted on or supported by a shaft 2143d. In addition, in implementations, drive element 2141c of pre-scan roller pair 2141 is mounted on or supported by shaft 2141d, drive element 2142c of post-scan roller pair 2142 is mounted on or supported by shaft 2142d, and drive element 2143c of exit roller pair 2143 is mounted on or supported by shaft 2143d. As such, in implementations, rollers 2141a of pre-scan roller pair 2141 are rotatably coupled with drive element 2141c via shaft 2141d, rollers 2142a of post-scan roller pair 2142 are rotatably coupled with drive element 2142c via shaft 2142d, and rollers 2143a of exit roller pair 2143 are rotatably coupled with drive element 2143c via shaft 2143d.

In implementations, belt 222 has a first side 222a and a second side 222b opposite first side 222a, such that first side 222a of belt 222 contacts a drive element of each of the opposing roller pairs 214. For example, in implementations, first side 222a of belt 222 contacts drive element 2141c of pre-scan roller pair 2141, contacts drive element 2142c of post-scan roller pair 2142, and contacts drive element 2143c of exit roller pair 2143.

In implementations, serpentine belt drive system 220 includes a plurality of idler pulleys 224 to guide belt 222 around the drive element of a respective one of the opposing roller pairs 214. For example, in implementations, serpentine belt drive system 220 includes an idler pulley 2241 to guide belt 222 around drive element 2141c of pre-scan roller pair 2141, an idler pulley 2242 to guide belt 222 around drive element 2142c of post-scan roller pair 2142, and an idler pulley 2243 to guide belt 222 around drive element 2143c of exit roller pair 2143.

In examples, to guide belt 222 around the drive element of a respective one of the opposing roller pairs 214, idler pulleys 224 are positioned and belt 222 is routed such that second side 222b of belt 222 contacts idler pulleys 224. More specifically, to guide belt 222 around the drive element of a respective one of the opposing roller pairs 214, idler pulleys 224 are positioned to provide contact at second side 222a of belt 222 adjacent the respective drive element. For example, in implementations, idler pulley 2241 contacts second side 222b of belt 222 adjacent drive element 2141c, idler pulley 2242 contacts second side 222b of belt 222 adjacent drive element 2142c, and idler pulley 2243 contacts second side 222b of belt 222 adjacent drive element 2143c. As such, idler pulleys 224 establish, increase and/or maintain a contact or wrap angle of belt 222 around the drive element of a respective one of the opposing roller pairs 214.

In implementations, serpentine belt drive system 220 includes a belt tensioner 226 to provide or maintain tension on belt 222. In one example, belt tensioner 226 includes an idler pulley 226a that contacts second side 222b of belt 222 and applies a bias force to belt 222. In one implementation, belt tensioner 226 is a spring-biased belt tensioner. Although illustrated as being adjacent exit roller pair 2143 and providing tension on belt 222 between drive element 2143c of exit roller pair 2143 and drive pulley 221, belt tensioner 226 may be positioned to provide or maintain tension on belt 222 elsewhere in a path of belt 222.

As illustrated in the example of FIG. 4, housing 210 of ADF 200 includes spaced sidewalls 211. As such, in examples, shafts 2141d, 2142d, and 2143d of opposing roller pairs 214 (FIG. 3), with respective rollers 2141a, 2142a, and 2143a, extend between and are rotatably supported by sidewalls 211. In one implementation, as illustrated in the example of FIG. 4, serpentine belt drive system 220 is provided outside of one of the sidewalls 211. More specifically, in one implementation, drive pulley 221, belt 222, idler pulleys 224, and belt tensioner 226 are provided on a same side of one of the sidewalls 211 opposite a side on which rollers of opposing roller pairs 214 are provided. As such, convenient access for and to serpentine belt drive system 220, for example, for assembly and/or maintenance, is provided.

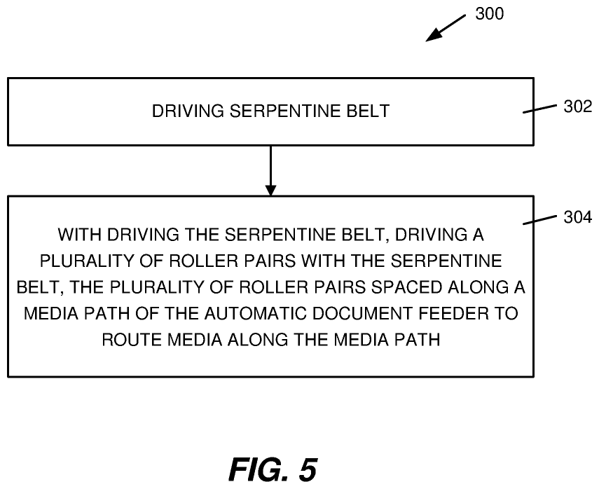

FIG. 5 is a flow diagram illustrating an example of a method 300 of driving rollers of an automatic document feeder, such as rollers of automatic document feeder 10, 130, 200, as illustrated in the examples of FIG. 1, FIG. 2, FIGS. 3 and 4, respectively.

At 302, method 300 includes driving a serpentine belt, such as driving belt 22, 222 of automatic document feeder 10, 200, as illustrated in the examples of FIG. 1, FIGS. 3 and 4, respectively.

At 304, method 300 includes, with the driving of the serpentine belt, driving a plurality of roller pairs with the serpentine belt, where the plurality of roller pairs are spaced along a media path of the automatic document feeder to route media along the media path, such as driving opposing roller pairs 14, 214 with belt 22, 222, with opposing roller pairs 14, 214 spaced along media path 12, 212 of automatic document feeder 10, 200, as illustrated in the examples of FIG. 1, FIGS. 3 and 4, respectively.

In one example, driving the plurality of roller pairs at 304, includes contacting a drive element for each of the plurality of roller pairs with a first side of the serpentine belt, such as contacting drive element 141c, 142c, 143c, 2141c, 2142c, 2143c for respective roller pairs 141, 142, 143, 2141, 2142, 2143 with first side 22a, 222a of belt 22, 222, as illustrated in the example of FIG. 1, FIGS. 3 and 4, respectively, and includes contacting a plurality of idler pulleys with a second side of the serpentine belt opposite the first side, where each of the plurality of idler pulleys are to guide the serpentine belt around the drive element for a respective one of the plurality of roller pairs, such as contacting idler pulleys 241, 242, 243, 2241, 2242, 2243 with second side 22b, 222b of belt 22, 222, as illustrated in the example of FIG. 1, FIGS. 3 and 4, respectively.

In one example, driving the plurality of roller pairs at 304, includes driving a pre-scan roller pair, a post-scan roller pair, and an exit roller pair with the serpentine belt, such as driving pre-scan roller pair 141, 2141, post-scan roller pair 142, 2142, and exit roller pair 143, 2143 with belt 22, 222, as illustrated in the example of FIG. 1, FIGS. 3 and 4, respectively.

With an automatic document feeder and method of driving rollers of an automatic document feeder, as disclosed herein, multiple opposing roller pairs of the automatic document feeder, such as a pre-scan roller pair, a post-scan roller pair, and an exit roller pair, may all driven by one belt. Whereas the use of multiple belts may generate slack, driving the multiple opposing roller pairs with a single belt, as disclosed herein, may help to synchronize all of the rollers. As such, scan image quality may be improved. In addition, parts may be eliminated and cost may be reduced.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein.

1. An automatic document feeder, comprising:
a media path to route media through the automatic document feeder;
a plurality of opposing roller pairs to route media along the media path; and
a serpentine belt drive system to drive a roller of each of the opposing roller pairs.

2. The automatic document feeder of claim 1, the serpentine belt drive system including a single, continuous belt to drive the roller of each of the opposing roller pairs.

3. The automatic document feeder of claim 2, the single, continuous belt having a first side and a second side opposite the first side,
the first side of the single, continuous belt to contact a drive element of each of the opposing roller pairs.

4. The automatic document feeder of claim 3, the serpentine belt drive system including a plurality of idler pulleys to guide the single, continuous belt around the drive element of a respective one of the opposing roller pairs,
the second side of the single, continuous belt to contact the plurality of idler pulleys.

5. The automatic document feeder of claim 3, the serpentine belt drive system including a belt tensioner to maintain tension on the single, continuous belt, the belt tensioner to contact the second side of the single, continuous belt.

6. The automatic document feeder of claim 1, the plurality of opposing roller pairs including a pre-scan roller pair.

7. The automatic document feeder of claim 1, the plurality of opposing roller pairs including a post-scan roller pair.

8. The automatic document feeder of claim 1, the plurality of opposing roller pairs including an exit roller pair.

9. A drive system for an automatic document feeder, comprising:
a drive pulley;
a single, continuous belt to be driven by the drive pulley; and
a plurality of roller pairs to be driven by the single, continuous belt, the roller pairs spaced along a media path of the automatic document feeder to route media along the media path.

10. The drive system of claim 9, further comprising:
a plurality of idler pulleys each associated with a respective one of the roller pairs to guide the single, continuous belt around a drive element for each of the respective one of the roller pairs.

11. The drive system of claim 9, further comprising:
a belt tensioner to maintain tension on the single, continuous belt.

12. The drive system of claim 9, the plurality of roller pairs including a pre-scan roller pair, a post-scan roller pair, and an exit roller pair.

13. A method of driving rollers of an automatic document feeder, comprising:
driving a serpentine belt; and
with the driving of the serpentine belt, driving a plurality of roller pairs with the serpentine belt, the plurality of roller pairs spaced along a media path of the automatic document feeder to route media along the media path.

14. The method of claim 13, wherein driving the plurality of roller pairs comprises:
contacting a drive element for each of the plurality of roller pairs with a first side of the serpentine belt, and
contacting a plurality of idler pulleys with a second side of the serpentine belt opposite the first side, each of the plurality of idler pulleys to guide the serpentine belt around the drive element for a respective one of the plurality of roller pairs.

15. The method of claim 13, wherein driving the plurality of roller pairs comprises:
driving a pre-scan roller pair, a post-scan roller pair, and an exit roller pair with the serpentine belt.
